(19) United States
(12) Patent Application Publication
(10) Pub. No.: US 2021/0219581 A1
(43) Pub. Date: Jul. 22, 2021

(54) EGG SUBSTITUTE MIXTURE

(71) Applicant: ZERO EGG LTD., Kfar Saba (IL)

(72) Inventor: Amiel DAVID, Har Adar (IL)

(21) Appl. No.: 17/054,877

(22) PCT Filed: May 13, 2019
(86) PCT No.: PCT/IL2019/050538

§ 371 Date: Nov. 12, 2020

Related U.S. Application Data
(60) Provisional application No. 62/670,815, filed on May 13, 2018.

(51) Int. Cl. A23L 15/00; A21D 2/26; A21D 2/18; A21D 13/045; A21D 2/02; A21D 13/064; A23L 11/00; A23L 33/185; A23L 29/262; A23L 29/256; A23L 33/145; A23L 33/24

(52) U.S. Cl. CPC A23L 15/35; A21D 2/266; A21D 2/188; A21D 2/183; A21D 13/045; A21D 2/02; A23V 2002/00; A23L 11/07; A23L 33/185; A23L 29/262; A23L 29/256; A23L 33/145; A23L 33/24; A21D 13/064

(57) ABSTRACT

The present invention is directed to compositions comprising inter alia, protein, Fabaceae flour and polysaccharide and use thereof, such as egg substitute compositions.

### CROSS REFERENCE TO RELATED APPLICATIONS

This application claims the benefit of priority to U.S. Provisional patent Application No. 62/670,815 filed May 13, 2018 entitled “EGG SUBSTITUTE MIXTURE”, the contents of which are incorporated herein by reference in their entirety.

### FIELD OF THE INVENTION

The present invention is directed to; inter alia, egg substitute compositions and methods of manufacturing, and using said compositions in the preparation of food products.

### BACKGROUND OF THE INVENTION

Eggs are one of the most widely consumed food products in the world. Eggs are a great source of protein, vitamins, iron amount other nutrients. In addition to its great nutritional value, eggs are also widely used and one of the essential ingredients in a variety of culinary applications, including savory and sweet baking and cooking. Eggs are useful in culinary since they provide a wide range of culinary properties, such as leavening, thickening, binding, coagulating, emulsifying and moisturizing.

Many attempts have been made to create an egg substitute that replaces the desired nutritional and culinary features of natural eggs. Some examples are mashed bananas and/or applesauce to replace eggs in baking, baking powder/baking soda mixtures to provide leavening, flour/water mixtures to provide binding and leavening. The drawback of such substitutes is that they provide only a single property of eggs in cooking.

Even though some egg replacers are commercially available, there is still a need for a good egg replacement that can replace a whole egg in all its culinary and nutritional features.

### SUMMARY OF THE INVENTION

According to one aspect, there is provided a composition comprising 25% to 80% (w/w) protein, 5% to 50% (w/w) Fabaceae flour, and 5% to 60% (w/w) polysaccharide.

In some embodiments, the composition comprises 1% to 20% (w/w) yeast extract.

In some embodiments, the composition comprises 1% to 20% (w/w) fiber.

In some embodiments, a protein and a polysaccharide are in a w/w ratio of 1:0.1 to 1:1.

In some embodiments, the polysaccharide is agar, methyl cellulose, carrageenan, or any combination thereof.

In some embodiments, the protein is protein is a plant protein, vegetable protein, a legume protein, a seed protein, a grain protein, a tuber protein, a root protein, a fruit protein, hemp protein, a nut protein, an algae protein, a seaweed protein, or any combination thereof.

In some embodiments, there is provided a composition comprising (a) 25% to 80% (w/w) soy protein, potato protein, or both; (b) 5% to 50% (w/w) pea flour; (c) 10% to 60% (w/w) carrageenan, methyl cellulose or both; (d) 1% to 20% (w/w) fiber; and (e) 1% to 20% (w/w) yeast extract.

In some embodiments, the composition comprises 1% to 20% (w/w) mung bean protein, chickpea protein, pea protein, or any combination thereof.

In some embodiments, the composition comprises 0.1% to 5% (w/w) salt.

In some embodiments, the composition comprises a stabilizer, a thickener, an emulsifier, a food coloring agent, a flavoring agent or any combination thereof.

In some embodiments, the stabilizer, the thickener, the emulsifier, the food coloring agent, the flavoring agent or any combination thereof, is/are in an amount of up to 15% (w/w) of the total composition.

In some embodiments, the composition is in a liquid form or dry powder form.

In some embodiments, the liquid comprises water, oil or both.

In some embodiments, there is provided a kit comprising the composition described herein and mixing instructions.

In some embodiments, the instructions comprise instructions for mixing the composition with a liquid and obtaining a mixture; and applying the mixture to the preparation of a food product, a recipe which requires an amount of egg yolks, egg whites, or whole eggs, thereby substituting the eggs in the food product or recipe.

In some embodiments, there is provided a method for substituting eggs in a food product or a recipe, comprising the step of: (a) mixing the composition described herein with a liquid and obtaining a mixture; (b) applying the mixture to the preparation of the food product, the recipe which requires an amount of egg yolks, egg whites, or whole eggs, thereby substituting the eggs in the food product or recipe.

In some embodiments, there is provided a method for preparing an egg food product, comprising substituting egg yolks, egg whites, or whole eggs needed for the preparation of the food product, with the composition described herein.

In some embodiments, there is provided a food product comprising the composition described herein.

In some embodiments, the food product has at least 80% of the texture, color, and flavor of an equivalent product prepared using eggs.

In some embodiments, the food product is devoid of an egg or any portion thereof.

In some embodiments, the food product is vegan.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

According to some embodiments, the present invention provides a composition comprising 25% to 80% (w/w) protein; 5% to 50% (w/w) Fabaceae flour; and 5% to 60% (w/w) polysaccharide.

In some embodiments, the composition comprises 10% to 80% (w/w) protein. In some embodiments, the composition comprises 28% to 80% (w/w), 30% to 80% (w/w), 40% to 80% (w/w), 50% to 80% (w/w), 20% to 50% (w/w), 30% to 60% (w/w), 20% to 70% (w/w), 25% to 70% (w/w), or 28% to 70% (w/w) protein, including any range therebetween.

In some embodiments, the composition comprises at least 20% (w/w), at least 25% (w/w), at least 30% (w/w), at least 40% (w/w), at least 50% (w/w), at least 60% (w/w), at least 70% (w/w), or at least 80% (w/w) protein, including any value therebetween.

In some embodiments, the composition comprises 5% to 50% (w/w), 10% to 50% (w/w), 20% to 50% (w/w), 30% to 50% (w/w), 5% to 20% (w/w), 5% to 30% (w/w), or 10% to 30% (w/w) Fabaceae flour, including any range therebetween.

In some embodiments, the composition comprises at least 5% (w/w), at least 10% (w/w), at least 15% (w/w), at least 20% (w/w), at least 25% (w/w), or at least 30% (w/w) Fabaceae flour, including any value therebetween.

In some embodiments, the composition comprises 5% to 60% (w/w) polysaccharide. In some embodiments, the composition comprises 10% to 60% (w/w), 20% to 60% (w/w), 30% to 60% (w/w), 40% to 60% (w/w), 10% to 30% (w/w), 10% to 40% (w/w), 20% to 40% (w/w), 5% to 30% (w/w), 5% to 25% (w/w), 5% to 20% (w/w), 5% to 18% (w/w), or 5% to 15% (w/w), polysaccharide, including any range therebetween.

In some embodiments, the composition comprises at least 5% (w/w), at least 10% (w/w), at least 15% (w/w), at least 20% (w/w), at least 25% (w/w), at least 30% (w/w), at least 40% (w/w), at least 50% (w/w), or at least 60% (w/w), polysaccharide, including any value therebetween.

In some embodiments, the composition further comprises 1% to 20% (w/w), 1% to 10% (w/w), 5% to 10% (w/w), 1% to 15% (w/w), 5% to 15% (w/w), or 5% to 20% (w/w) yeast extract, including any range therebetween.

In some embodiments, the composition comprises at least 1% (w/w), at least 2% (w/w), at least 3% (w/w), at least 4% (w/w), at least 5% (w/w), at least 6% (w/w), at least 7% (w/w), at least 8% (w/w), at least 9% (w/w), at least 10% (w/w), at least 15% (w/w), yeast extract, or at least 20% (w/w) yeast extract, including any value therebetween.

In some embodiments, the composition further comprises 1% to 20% (w/w), 1% to 10% (w/w), 5% to 10% (w/w), 1% to 15% (w/w), 5% to 15% (w/w), or 5% to 20% (w/w) fiber, including any range therebetween.

In some embodiments, the composition comprises at least 1% (w/w), at least 2% (w/w), at least 3% (w/w), at least 4% (w/w), at least 5% (w/w), at least 6% (w/w), at least 7% (w/w), at least 8% (w/w), at least 9% (w/w), at least 10% (w/w), at least 15% (w/w), or at least 20% (w/w) fiber, including any value therebetween.

In some embodiments, the composition comprises protein and polysaccharide in a w/w ratio of 1:0.1 to 1:1. In some embodiments, the composition comprises protein and polysaccharide in a w/w ratio of 1:0.5 to 1:9. In some embodiments, the composition comprises protein and polysaccharide in a w/w ratio of 1:0.2 to 1:1. In some embodiments, the composition comprises protein and polysaccharide in a w/w ratio of 1:0.3 to 1:1.

In some embodiments, the composition further comprises 0.1% to 5% (w/w) salt. In some embodiments, the composition further comprises 0.1% to 1% (w/w), 0.1% to 0.2% (w/w), 0.1% to 0.3% (w/w), 0.1% to 0.5% (w/w), 0.1% to 0.7% (w/w), 0.1% to 2% (w/w), 0.1% to 3% (w/w), 0.1% to 4% (w/w), 1% to 2% (w/w), 1% to 3% (w/w), 1% to 4% (w/w), or 1% to 5% (w/w) salt, including any range therebetween.

In some embodiments, the composition comprises 25% to 80% (w/w) soy protein, 5% to 50% (w/w) pea flour, 10% to 60% (w/w) carrageenan, methyl cellulose or both, 1% to 20% (w/w) fiber, and 1% to 20% (w/w) yeast extract.

In some embodiments, the composition comprises 25% to 80% (w/w) soy protein, potato protein, or both, 5% to 50% (w/w) pea flour, 10% to 60% (w/w) carrageenan, methyl cellulose or both, 1% to 20% (w/w) fiber, and 1% to 20% (w/w) yeast extract.

In some embodiments, the composition further comprises 1% to 20% (w/w) mung bean protein, chickpea protein, pea protein, or any combination thereof.

In some embodiments, the composition comprises 25% to 80% (w/w) soy protein and potato protein, 5% to 50% (w/w) pea flour, 10% to 60% (w/w) carrageenan and methyl cellulose, 1% to 20% (w/w) cellulose fiber and inulin fiber, and 1% to 20% (w/w) yeast extract.

In some embodiments, the composition comprises 25% to 80% (w/w) soy protein, potato protein, mung bean protein, chickpea protein, pea protein, or any combination thereof, 10% to 60% (w/w) carrageenan and agar, 1% to 20% (w/w) cellulose fiber and inulin fiber, 5% to 50% (w/w) pea flour, and 1% to 20% (w/w) yeast extract.

In some embodiments, the composition comprises at least 10% (w/w), at least 20% (w/w), at least 30% (w/w), at least 40% (w/w), at least 50% (w/w), at least 60% (w/w), or at least 70% (w/w) soy protein, including any value therebetween. In some embodiments, the composition comprises up to 85% (w/w), up to 70% (w/w), up to 60% (w/w), up to 50% (w/w), up to 40% (w/w), up to 30% (w/w), up to 25% (w/w), or up to 20% (w/w), soy protein, including any value therebetween.

In some embodiments, the composition comprises at least 0.5% (w/w), at least 0.9% (w/w), at least 1% (w/w), at least 3% (w/w), at least 5% (w/w), at least 10% (w/w), at least 15% (w/w), at least 20% (w/w), at least 30% (w/w), at least 40% (w/w), at least 50% (w/w), at least 60% (w/w), or at least 70% (w/w) potato protein, including any value therebetween. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), potato protein, including any value therebetween.

In some embodiments, the composition comprises at least 0.9% (w/w), at least 1% (w/w), at least 3% (w/w), at least 5% (w/w), at least 10% (w/w), at least 15% (w/w), at least 20% (w/w), at least 30% (w/w), at least 40% (w/w), at least 50% (w/w), at least 60% (w/w), or at least 70% (w/w) mung bean protein, including any value therebetween. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), mung bean protein, including any value therebetween.

In some embodiments, the composition comprises at least 0.9% (w/w), at least 1% (w/w), at least 3% (w/w), at least 5% (w/w), at least 10% (w/w), at least 15% (w/w), at least 20% (w/w), at least 30% (w/w), at least 40% (w/w), at least 50% (w/w), at least 60% (w/w), or at least 70% (w/w) chickpea protein, including any value therebetween. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), chickpea protein, including any value therebetween.

In some embodiments, the composition comprises at least 0.5% (w/w), at least 0.9% (w/w), at least 1% (w/w), at least 3% (w/w), at least 5% (w/w), at least 10% (w/w), at least 15% (w/w), at least 20% (w/w), at least 30% (w/w), at least 40% (w/w), at least 50% (w/w), at least 60% (w/w), or at least 70% (w/w) pea protein, including any value therebetween. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), pea protein, including any value therebetween.

In some embodiments, the composition comprises at least 5% (w/w), at least 10% (w/w), at least 15% (w/w), at least 20% (w/w), at least 25% (w/w), at least 30% (w/w), at least 35% (w/w), pea flour, including any value therebetween. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), pea flour, including any value therebetween.

In some embodiments, the composition comprises at least 10% (w/w) carrageenan, methyl cellulose or both. In some embodiments, the composition comprises at least 20% (w/w), at least 30% (w/w), at least 40% (w/w), or at least 50% (w/w) carrageenan, methyl cellulose or both. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), carrageenan, methyl cellulose or both, including any value therebetween.

In some embodiments, the composition comprises at least 10% (w/w), at least 20% (w/w), at least 30% (w/w), at least 40% (w/w), or at least 50% (w/w), carrageenan, including any value therebetween. In some embodiments, the composition comprises up to 50% (w/w), up to 40% (w/w), up to 30% (w/w), up to 25% (w/w), or up to 20% (w/w), carrageenan, including any value therebetween.

In some embodiments, the composition comprises at least 10% (w/w), at least 20% (w/w), at least 30% (w/w), at least 40% (w/w), or at least 50% (w/w), methyl cellulose. In some embodiments, the composition comprises up to 80% (w/w), up to 70% (w/w), up to 60% (w/w), up to 50% (w/w), up to 40% (w/w), up to 30% (w/w), up to 25% (w/w), or up to 20% (w/w), methyl cellulose, including any value therebetween.

In some embodiments, the composition comprises at least 5% (w/w), at least 10% (w/w), at least 20% (w/w), at least 30% (w/w), at least 40% (w/w), or at least 50% (w/w), agar, including any value therebetween. In some embodiments, the composition comprises up to 70% (w/w), up to 650% (w/w), up to 60% (w/w), up to 50% (w/w), up to 40% (w/w), up to 30% (w/w), up to 25% (w/w), or up to 20% (w/w), agar, including any value therebetween.

In some embodiments, a composition as described herein is in powder form. In some embodiments, a composition as described herein in powder form has a self-life of about 12 months. In some embodiments, a composition as described herein in powder form has a self-life of 3 to 36 months. In some embodiments, a composition as described herein in powder form has a self-life of 3 to 24 months. In some embodiments, a composition as described herein in powder form has a self-life of 3 to 18 months. In some embodiments, a composition as described herein in powder form has a self-life of 6 to 24 months. In some embodiments, a composition as described herein in powder form has a self-life of 6 to 18 months. In some embodiments, a composition as described herein in powder form has a self-life of 3 to 12 months. In some embodiments, a composition as described herein in powder form has a self-life of 6 to 18 months.

In some embodiments, a composition as described herein is in liquid form. In some embodiments, a composition as described herein in liquid form is pasteurized. In some embodiments, a composition as described herein in liquid form is kept refrigerated. In some embodiments, a composition as described herein in liquid form is kept frozen. In some embodiments, a composition as described herein in liquid form kept frozen, has a self-life of about 12 months.

In some embodiments, a composition as described herein, comprises a liquid. In some embodiments, the liquid is aqueous. In some embodiments, the liquid comprises water, oil or both. In some embodiments, the liquid composition is characterized with a viscosity in the range of 10,000 cP to 300 cP, 8,000 cP to 300 cP, 7,000 cP to 300 cP, 6,900 cP to 300 cP, 6,850 cP to 300 cP, 6,000 cP to 300 cP, 7,000 cP to 400 cP, 7,000 cP to 500 cP, 9,900 cP to 500 cP, or 7,850 cP to 500 cP, including any range therebetween.

In some embodiments, the ratio between the composition without liquid oil, aqueous solution, water or both and the liquid oil, aqueous solution, water or both is in the range of 1:15 to 1:5, 1:14 to 1:5, 1:13 to 1:5, 1:12 to 1:5, 1:12 to 1:5, 1:12 to 1:5, 1:12 to 1:6, 1:12 to 1:7, or 1:12 to 1:8, including any range therebetween.

In some embodiments, the ratio between the powder composition and oil, aqueous solution, water or both, is in the range of 1:15 to 1:5, 1:14 to 1:5, 1:13 to 1:5, 1:12 to 1:5, 1:12 to 1:5, 1:12 to 1:5, 1:12 to 1:6, 1:12 to 1:7, or 1:12 to 1:8, including any range therebetween.

In some embodiments, the oil is a vegetable-based oil. Examples of vegetable oils that may be used according to the present invention include, but are not limited to, soybean oil, safflower oil, linseed oil, corn oil, sunflower oil, olive oil, canola oil, sesame oil, cottonseed oil, palm oil, rapeseed oil, tung oil, or a blend of any of these oils. Alternatively, any partially hydrogenated vegetable oils or genetically modified vegetable oils can be used. Examples of partially hydrogenated vegetable oils or genetically modified vegetable oils include, but are not limited to, high oleic safflower oil, high oleic soybean oil, high oleic peanut oil, high oleic sunflower oil and high erucic rapeseed oil (crambe oil).

### Protein

In some embodiments, the protein is a plant protein. In some embodiments, the protein source, is plant-based. In some embodiments, the protein is a vegetable protein, a legume protein, a seed protein, a grain protein, a tuber protein, a root protein, a fruit protein, hemp protein, a nut protein, an algae protein, and/or a seaweed protein. In some embodiments, the protein comprises soy protein, potato protein, chickpea protein, pea protein, mung bean protein, and any combination thereof. In some embodiments, the protein is soy protein. In some embodiments, the protein is potato protein. In some embodiments, the protein is soy protein and potato protein. In some embodiments, a composition as described herein is a composition comprising a high protein content. In some embodiments, the protein is soy protein, mung bean protein, potato protein, chickpea protein, and pea protein. In some embodiments, soy protein and mung bean protein are used in a combination. In some embodiments, either soy protein or mung bean protein is used. In some embodiments, chickpea protein and pea protein are used in a combination. In some embodiments, either chickpea protein or pea protein is used. In some embodiments, the ratio of soy protein/mung bean protein: chickpea protein/pea protein: potato protein is in the range of 20:3:0.9 to 60:6:2, 25:3:2 to 55:6:0:2, 30:5:1 to 50:5:1.5, 30:5:1.0 to 25.5:4:1.5, 34:5:1 to 60:6:2, 50:5:1.5 to 60:6:2, or 25.5:4:1.5 to 60:6:2, including any range therebetween. In some embodiments, a composition as described herein comprises at least 1.5% of chickpea protein. In some embodiments, a composition as described herein comprises at least 1.5% of chickpea protein, and potato protein. In some embodiments, a composition as described herein comprises at least 1.5% of chickpea protein, potato protein and pea protein. In some embodiments, a composition as described herein comprises chickpea protein, potato protein and pea protein in a ratio of 5:1:0 to 5:1.5:1. In some embodiments, a composition as described herein comprises chickpea protein, potato protein and pea protein in a ratio of 5:1:0, 5:1:1, or 5:1.5:1. In some embodiments, the protein can comprise one or more plant proteins. In some embodiments, the one or more plant proteins include but are not limited to pea proteins, isolates, and/or concentrates; garbanzo (chickpea) proteins, isolates, and/or concentrates; fava bean proteins, isolates, and/or concentrates; soy proteins, isolates, and/or concentrates; rice proteins, isolates, and/or concentrate; potato proteins, isolates, and/or concentrates; hemp proteins, isolates, and/or concentrates; or any combinations thereof. In some embodiments, the pea proteins can be derived from green peas, yellow peas, or a combination thereof. As used herein, the term “protein” refers to organic compounds made of amino acids arranged in a linear chain.

### Flour

In some embodiments, the composition comprises Fabaceae flour. In some embodiments, flour is Fabaceae flour. In some embodiments, the Fabaceae four is pea flour. In some embodiments, a composition as described herein comprises 5% to 30% (w/w), 8% to 30% (w/w), 10% to 30% (w/w), 12% to 30% (w/w), 15% to 30% (w/w), 5% to 25% (w/w), 5% to 20% (w/w), 8% to 25% (w/w), 10% to 25% (w/w), or 10% to 20% (w/w) pea flour pea flour, including any range therebetween. In some embodiments, the flour is derived from beans, peas, lentils, peanuts, blackgram or any member of the Leguminosae (Fabaceae) family. In some embodiments, flour is a powder ground from grains, seeds, roots, or other sources. As it is used herein, the term “Fabaceae” or “Leguminosae” refers to a family of plants, commonly known as legume family, pea family or bean family. As used herein, the term “pea” refers to all peas including chickpeas.

### Polysaccharide

According to some embodiments, the present invention provides a composition comprising polysaccharide. In some embodiments, the polysaccharide acts as a stabilizer. In some embodiments, the polysaccharide comprises carrageenan, methyl cellulose, agar, or any combination thereof. In some embodiments, the composition comprises carrageenan, methyl cellulose, agar, or any combination thereof. In some embodiments, the composition comprises 1% to 30% (w/w), 2% to 30% (w/w), 1% to 20% (w/w), 1% to 15% (w/w), 3% to 15% (w/w), or 5% to 15% (w/w), agar, including any range therebetween. In some embodiments, the composition comprises 1% to 30% (w/w), 2% to 30% (w/w), 1% to 20% (w/w), 1% to 15% (w/w), 3% to 15% (w/w), or 5% to 15% (w/w), carrageenan, including any range therebetween. In some embodiments, the composition comprises 1% to 30% (w/w), 2% to 30% (w/w), 1% to 20% (w/w), 1% to 15% (w/w), 3% to 15% (w/w), or 5% to 15% (w/w), agar and carrageenan, including any range therebetween. In some embodiments, the composition comprises 3% to 10% (w/w), 3.5% to 9% (w/w), 4% to 8% (w/w), 4.5% to 8% (w/w), or 4.5% to 7.5% (w/w), methyl cellulose, including any range therebetween. In some embodiments, the composition comprises 5% to 15% (w/w) agar, carrageenan, or both, and 4.5% to 7.5% (w/w) methyl cellulose. In some embodiments, the ratio between agar and methyl cellulose is in the range of 7:1 to 1.5:1, 5:1 to 1.5:1, 4:1 to 1.5:1, 3:1 to 1.5:1, including any range therebetween. In some embodiments, the ratio between carrageenan and methyl cellulose is in the range of 7:1 to 1.5:1, 5:1 to 1.5:1, 4:1 to 1.5:1, 3:1 to 1.5:1, including any range therebetween. In some embodiments, the ratio between agar and carrageenan and methyl cellulose is in the range of 7:1 to 1.5:1, 5:1 to 1.5:1, 4:1 to 1.5:1, 3:1 to 1.5:1, including any range therebetween. As used herein, the term “carrageenan” refers to a family of linear sulfated polysaccharides which are usually extracted from red seaweeds. All carrageenans are high molecular weight sulfated polysaccharides made up of repeating galactose units and 3,6 anhydrogalactose, both sulfated and non-sulfated. The units are joined by alternating alpha 1-3 and beta 1-4 glycosidic linkages. Various types of carrageenans exist. Their structures differ in 3,6 anhydrogalactose and ester sulphate content. The main types are kappa, lambda and iota. The primary differences which influence the properties of kappa, iota and lambda carrageenan are the number and position of the ester sulfate groups on the repeating galactose units. As used herein, “polysaccharide” refers to a compound containing a plurality of monosaccharides which are linked together by glycosidic bonds

### Fiber

In some embodiments, the fiber is dietary fiber. In some embodiments, the fiber comprises cellulose, inulin, or both. In some embodiments, the dietary fiber is cellulose. In some embodiments, the dietary fiber is inulin. In some embodiments, the dietary fiber is cellulose and inulin. In some embodiments, a composition as described herein comprises 5% to 15% (w/w) fiber. In some embodiments, the fiber is bran, e.g., a wheat bran, oat bran, corn bran, rice bran, or other bran. In some embodiments, the bran can be micronized into a fine powder.

As used herein, the term “fiber” refers to non-starch carbohydrates in the form of polysaccharide. Fiber can be soluble in water or insoluble in water. Many microalgae produce both soluble and insoluble fiber, typically residing in the cell wall. As used herein, the term “dietary fiber” refers to non-starch carbohydrates found in plants and other organisms containing cell walls, including microalgae. Dietary fiber can be soluble (dissolved in water) or insoluble (not able to be dissolved in water). Soluble and insoluble fiber makes up total dietary fiber.

pH

In some embodiments, the compositions described herein, have a pH in a range of about 5-9. In some embodiments, the compositions described herein, have a pH in a range of about 5.5-8.5. In some embodiments, the compositions described herein, have a pH in a range of about 6-8. In some embodiments, the compositions described herein, have a pH in a range of about 6.5-7.5. In some embodiments, the compositions described herein, have a pH in a range of about 7.5-8.5. In some embodiments, the compositions described herein, have a pH of about 6. In some embodiments, the compositions described herein, have a pH of about 6.5. In some embodiments, the compositions described herein, have a pH of about 7. In some embodiments, the compositions described herein, have a pH of about 7.5. In some embodiments, the compositions described herein, have a pH of about 8. In some embodiments, the compositions described herein, have a pH of about 8.5.

### Coloring Agents

In some embodiments, the composition comprises one or more coloring agents. Various natural or artificial coloring agents are known to those skilled in the art, and can include, for example, caretonoids such as beta-carotene, turmeric, annatto, mango yellow, or palm-based oils. In some embodiments, the composition comprises beta-carotene. In some embodiments, the composition comprises 0.1% to 20% (w/w), 0.5% to 15% (w/w), 0.3% to 15% (w/w), 0.4% to 15% (w/w), 0.5% to 15% (w/w), 0.4% to 10% (w/w), 0.5% to 5% (w/w), or 0.4% to 2% (w/w) coloring agent.

### Flavoring Agents

In some embodiments, the composition comprises one or more flavoring agents. In some embodiments, the composition comprises yeast, sugar, salt, and any combination thereof. Various natural or artificial flavoring agents are known to those skilled in the art, and can include, for example, salt, spices, sugar, sweeteners, monosodium glutamate, sulfuric flavoring agents such as black salt, or other flavoring agents. In some embodiments, the composition comprises 0.1% to 20% (w/w) flavoring agent. In some embodiments, the composition comprises 0.5% to 15% (w/w) flavoring agent.

### Other Agents

In some embodiments, the composition further comprises an emulsifier. In some embodiments, the emulsifier comprises lecithin. In some embodiments, the composition comprises 0.1% to 5% (w/w), 0.2% to 5% (w/w), 0.3% to 5% (w/w), 0.4% to 5% (w/w), 0.5% to 5% (w/w), 0.5% to 4% (w/w), or 0.5% to 3% (w/w), of an emulsifier, including any range therebetween.

In some embodiments, the composition comprises a thickener. In some embodiments, the thickener comprises Gellan gum. As used herein, “Gellan gum” refers to the extracellular polysaccharide obtained by the aerobic fermentation of the microorganism Pseudomonas elodea in a suitable nutrient medium. Gellan gum refers to the various forms of native, deacetylated, deacetylated clarified, partially deacetylated, and partially deacetylated clarified.

In some embodiments, the composition comprises 0.5% to 15% (w/w), 1% to 15% (w/w), 0.5% to 12% (w/w), 0.5% to 10% (w/w), or 1% to 10% (w/w), oil, including any range therebetween.

### Food Product

In some embodiments, the present invention provides a food product comprising the compositions described herein. In some embodiments, the present invention provides a food product prepared using the compositions described herein. In some embodiments, the food product prepared with the compositions described herein, is indistinguishable from an equivalent food product prepared with eggs.

In some embodiments, the food product prepared with the compositions described herein, has at least 80%, at least 85% of, at least 90% of the characteristics and sensory properties of food product prepared using eggs. In some embodiments, the food product has at least 80% of the texture, color, and flavor of an equivalent product prepared using eggs. In some embodiments, the food product has at least 85% of the texture, color, and flavor of an equivalent product prepared using eggs. In some embodiments, the food product has at least 90% of the texture, color, and flavor of an equivalent product prepared using eggs. In some embodiments, the food product has at least 60% of the odor profile of an equivalent product prepared using eggs. In some embodiments, the food product has at least 65%, at least 70%, at least 75%, at least 80%, at least 85%, at least 90%, or at least 95%, of the odor profile of an equivalent product prepared using eggs. In some embodiments, the food product has at least 60% of the consistency of an equivalent product prepared using eggs. In some embodiments, the food product has at least 65%, at least 70%, at least 75%, at least 80%, at least 85%, at least 90%, or at least 95%, of the consistency of an equivalent product prepared using eggs. In some embodiments, the food product has at least 95% of the texture, color, and flavor of an equivalent product prepared using eggs.

In some embodiments, the food product is devoid of an egg or any portion thereof.

As used herein, the term “egg” for example, as used when describing a “product devoid of an egg” composition, refers to the animal product (i.e., an egg laid by a bird or fowl, such as a chicken, quail or duck) or any component of the animal product. The term “egg or any portion thereof” refers to any edible egg or part thereof including, but not limited to whole eggs, egg yolks, or egg whites or combinations thereof.

In some embodiments, the food product is vegan.

As used herein, the term “vegan” refers to properties of the components, and indicates that the components are not sourced from or derived from an animal or animal product. As such, the components that are “vegan” are free of any animal products or animal byproducts. What constitutes an animal product or byproduct is well known in this field, and to those following a vegetarian or vegan diet. In particular, the term “animal product” refers to any animal parts, animal byproducts, or products produced by an animal. Some examples of materials that would be considered “animal products” include those parts of the animal that are consumable or typically prepared for consumption by humans (including, e.g., fat, flesh, blood, etc.). Products produced by an animal are also considered “animal products” as used herein, and refer to the products produced by an animal without slaughtering the animal, (e.g., milk, eggs, honey, etc.). “Animal byproducts” are products that are typically not consumable by themselves but are the byproducts of slaughtering animals for consumption, e.g., bones, carcasses, etc. However, animal byproducts are often processed into human consumable foodstuffs, some well-known examples of which include gelatin, casein, whey, rennet, etc. As used herein, these processed animal byproducts (e.g., gelatin, casein, whey, rennet, etc.) are encompassed by the term “animal byproducts.” As described herein, “vegan” and “plant-based” components or ingredients are substantially free (or in some embodiments, completely free) of such animal products and byproducts.

In some embodiments, compositions and food products as described herein are suitable for a vegan diet and/or a vegetarian diet. For example, in embodiments in which the composition is suitable for a vegan diet, the composition may include primarily plant-based components such that the composition contains substantially no animal products, animal byproducts, or substantially no components derived from these animal sources.

In some embodiments, the compositions may be used as a substitute for eggs in emulsions (e.g., mayonnaise and similar emulsions), or in baking mixes. Additionally, the compositions may be used in place of raw eggs in traditional applications, such as scrambled eggs, omelets, frittatas, etc. In some embodiments, the food product is a baked food product. In some embodiments, the food product is a baked food product such as but not limited to cookies, muffins, cupcakes, brownies, cake, custard, pancakes, breads, waffles, pastries, pies, tarts, scones, pretzels, crackers scramble, omelet, quiche, pasta, sauce, dressing. In some embodiments, the composition described herein are used as a replacement for whole eggs, egg yolks, and/or egg whites in food products. The composition described herein includes culinary properties that emulate egg (i.e., the animal product). Specifically, an egg substitute according to embodiments of the present invention emulates the leavening, binding, moisturizing and thickening properties of natural egg (i.e., the animal product).

### The Kit

According to some embodiments, the present invention provides a kit comprising the composition described herein.

According to some embodiments, the kit is utilized by mixing the composition described herein with a liquid and obtaining a mixture and applying the mixture to the preparation of a food product, a recipe which requires an amount of egg yolks, egg whites, or whole eggs, thereby substituting the eggs in the food product or recipe.

In some embodiments, the kit comprises instructions for by mixing the composition described herein with a liquid and obtaining a mixture and applying the mixture to the preparation of a food product, a recipe which requires an amount of egg yolks, egg whites, or whole eggs, thereby substituting the eggs in the food product or recipe.

In some embodiments, of the subject kits, the composition described herein is packaged within a container.

In some embodiments, the container is made of a material selected from the group consisting of thin-walled film or plastic (transparent or opaque), paperboard-based, foil, rigid plastic, metal (e.g., aluminum), glass, etc.

In some embodiments, the content of the kit is packaged, as described below, to allow for storage of the components until they are needed.

In some embodiments, some or all components of the kit may be packaged in suitable packaging to maintain sterility.

In some embodiments, of the subject kits, the composition described herein is stored in separate containers within the main kit containment element e.g., box or analogous structure, may or may not be an airtight container, e.g., to further preserve the sterility of some or all of the components of the kit.

In some embodiments, the dosage amount of the composition described herein provided in a kit may be sufficient for a single application or for multiple applications.

In those embodiments, the kit may have multiple dosage amounts of the composition described herein packaged in a single container, e.g., a single box, tube, bottle, vial, and the like.

In some embodiments, the kit may have multiple dosage amounts of the composition described herein individually packaged such that certain kits may have more than one container of the composition described herein.

In some embodiments, multiple dosage amounts of the composition described herein may be packed in single separate containers.

In some embodiments, the kit contains instructions for preparing the composition used therein and for how to practice the methods of the invention.

In some embodiments, the kit further comprises a measuring utensil such as measuring spoon or a measuring cup.

In some embodiments, the instructions may be recorded on a suitable recording medium or substrate. For example, the instructions may be printed on a substrate, such as paper or plastic, etc.

In some embodiments, the instructions may be present in the kit as a package insert, in the labeling of the container of the kit or components thereof (i.e., associated with the packaging or sub-packaging) etc. In other embodiments, the instructions are present as an electronic storage data file present on a suitable computer readable storage medium, e.g. CD-ROM, diskette, etc. In other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

### The Method

In some embodiments, the present invention provides a method for preparing a food product, comprising substituting egg yolks, egg whites, whole eggs or any combination thereof, needed for the preparation of the food product, with a composition described herein.

In some embodiments, the present invention provides a method for preparing a food product, comprising substituting egg yolks needed for the preparation of the food product, with a composition described herein. In some embodiments, the present invention provides a method for preparing a food product, comprising substituting egg whites needed for the preparation of the food product, with a composition described herein. In some embodiments, the present invention provides a method for preparing a food product, comprising substituting whole eggs needed for the preparation of the food product, with a composition described herein.

In some embodiments, the present invention provides a method for preparing an egg food product, comprising substituting egg yolks needed for the preparation of the food product, with a liquid composition described herein. In some embodiments, the amount of eggs in volume needed for preparing a food product, is substituted with the same amount in volume of a liquid composition as described herein.

As used herein, the term “egg food product” refers to any food product which may require eggs for its preparation, and any food product that may contain eggs. Non-limiting examples of food products include emulsions (e.g., mayonnaise and similar emulsions), scrambled eggs, omelets, frittatas, cookies, muffins, cupcakes, brownies, cake, custard, pancakes, breads, waffles, pastries, pies, tarts, scones, pretzels, crackers, quiche, pasta, sauce, dressing.

In some embodiments, the present invention provides a method for preparing a substituting eggs in a food product or a recipe, comprising the step of: (a) mixing a composition described herein with a liquid and obtaining a mixture; (b) applying the mixture to the preparation of a food product, a recipe which requires an amount of egg yolks, egg whites, or whole eggs, thereby substituting the eggs in the food product or recipe.

In some embodiments, mixing the composition and the liquid is in the range of 1:15 to 1:5, 1:14 to 1:5, 1:13 to 1:5, 1:12 to 1:5, 1:12 to 1:5, 1:12 to 1:5, 1:12 to 1:6, 1:12 to 1:7, or 1:12 to 1:8, including any range therebetween.

In some embodiments, a liquid composition as described herein can be used after 1 day of being kept refrigerated. In some embodiments, a liquid composition as described herein can be used after 2 days of being kept refrigerated. In some embodiments, a liquid composition as described herein can be used after 3 days of being kept refrigerated. In some embodiments, a liquid composition as described herein can be used after 4 days of being kept refrigerated. In some embodiments, a liquid composition as described herein can be used after 5 days of being kept refrigerated. In some embodiments, a liquid composition as described herein can be used after 6 days of being kept refrigerated. In some embodiments, a liquid composition as described herein can be used after 7 days of being kept refrigerated.

In some embodiments, a liquid composition as described herein can be used after 1 day of being kept frozen. In some embodiments, a liquid composition as described herein can be used after 2 days of being kept frozen. In some embodiments, a liquid composition as described herein can be used after 3 days of being kept frozen. In some embodiments, a liquid composition as described herein can be used after 4 days of being kept frozen. In some embodiments, a liquid composition as described herein can be used after 5 days of being kept frozen. In some embodiments, a liquid composition as described herein can be used after 6 days of being kept frozen. In some embodiments, a liquid composition as described herein can be used after 7 days of being kept frozen.

In some embodiments, a liquid composition as described herein can be used after 20 days, 1 month, 2 months, 3 months, 5 months, 7 months, 8 months or 12 months, of being kept frozen, including any value therebetween.

In some embodiments, the liquid is water. In some embodiments, the liquid is water, oil or both. In some embodiments, the oil is a vegetable-based oil as described herein.

In some embodiments, the liquid is any plant-based liquid. In some embodiments, the liquid is any liquid suitable for human consumption. In some embodiments, the liquid is soy milk, almond milk, coconut milk, rice milk, juice or any combination thereof.

As used herein, the term “plant-based” refers to the vegan properties of the components and indicates that the components are not sourced from or derived from an animal or animal product.

As used herein, the term “egg,” refers to the animal product (i.e., an egg laid by a bird or fowl, such as a chicken, quail or duck) or any component of the animal product.

As used herein, the terms “egg substitute,” “egg substitute composition” and like terms refer to compositions that do not include the animal product but that can be used to simulate, replace or substitute the animal product (or any component thereof) in various applications.

In some embodiments, an egg substitute composition as described herein includes culinary properties of an egg (i.e., the animal product). In some embodiments, an egg substitute composition as described herein, matches the leavening, binding, moisturizing and thickening properties of natural egg (i.e., the animal product).

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided In some embodiments, and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Liquid Mixture Preparation Instructions

After mixing the powder with water, according to the preparation instructions, the product was kept in the freezer (−18° C.). After defrosting, the liquid product can be safely used for 7 days.

Preparation instructions: For Each 1 kg of mix powder add 9 liters of cold water (0-4° C.). Add the water first and then the powder to the mixer (Stephan) mix in high speed for 4-6 min until you get a smooth and creamy texture.

Usage example in a cinnamon bun recipe: Replace the amount of eggs needed in volume with an equivalent volume of liquid egg replacer.

Usage example in Mayonnaise: Replace the amount of eggs needed in volume with 14% volume of liquid egg replacer.

Usage example in omelet: pour onto a skillet an equivalent volume of liquid egg replacer as would be used per egg volume.

### Example 2

### Egg Substitute Compositions

Table 1 presents Composition 1 of an egg substitute mixture.

TABLE 1

| Ingredient | % in powder |
|---|---|
| Agar | 11.48% |
| Pea flour | 11.96% |
| Cellulose fibers | 10.52% |
| Lecithin | 1.02% |
| Gellan | 1.44% |
| Soy protein isolate | 34.43% |
| Potato protein | 0.97% |
| Chickpea protein | 4.79% |
| Methocel | 5.07% |
| Dried Yeast | 8.61% |
| sugar | 3.82% |
| Table salt | 4.86% |
| color powder | 1.04% |
| | 100.00% |

Table 2 presents Composition 2 of an egg substitute mixture.

TABLE 2

| Ingredient | % in powder | Function |
|---|---|---|
| Soy protein isolate | 20.0-80.0 | Protein |
| Mung bean Protein | 1.0-20.0 | Protein |
| Potato Protein | 0.5-20.0 | Protein |
| Chickpea Protein | 1.0-10.0 | Protein |
| Pea Protein | 0.5-20.0 | Protein |
| Carrageenan | 5.0-20.0 | Stabilizer |
| Agar | 5.0-20.0 | Stabilizer |
| Cellulose fibers | 5.0-15.0 | Fiber |
| Inulin | 5.0-15.0 | Fiber |
| Lecithin | 0.5-3.0 | Emulsifier |
| Gellan | 0.5-2.5 | Thickener |
| Oil (in liquid) | 1.0-10.0 | Texture |
| Methyl Cellulose | 4.0-7.0 | Texture |
| Pea flour | 10.0-20.0 | Texture |
| Dried Yeast | 5.0-13.0 | Flavor |
| Sugar | 0.0-10.0 | Flavor |
| Table Salt | 3.0-6.0 | Flavor |
| Flavor Powder | 0.5-5.0 | Flavor |
| Color Powder | 0.4-2.0% | Color |

Table 3 presents Composition 3, a first generation egg substitute mixture.

TABLE 3

| Ingredient | % in powder | Optimal range (%) |
|---|---|---|
| Agar | 11.48% | 7.5-15.0 |
| Pea flour | 11.96% | 8.0-15.0 |
| Cellulose fibers | 10.52% | 8.5-15.0 |
| Lecithin | 1.02% | 0.5-3.0 |
| Gellan | 1.44% | 0.5-2.5 |
| Soy protein isolate | 34.43% | 30.0-35.0 |
| Potato protein | 0.97% | 0.9-5.5 |
| Chickpea protein | 4.79% | 1.0-5.5 |
| Methyl Cellulose | 5.07% | 5.0-8.0 |
| Dried Yeast | 8.61% | 7.5-12.0 |
| Sugar | 3.82% | 1.0-5.0 |
| Table salt | 4.86% | 2.0-7.0 |
| Color powder | 1.04% | 0.5-1.5 |
| | 100.00% | |

Table 4 presents Composition 4, a high protein formula of an egg substitute mixture.

TABLE 4

| | % in | | Optimal |
|---|---|---|---|
| Ingredient | powder | Function | range (%) |
| Soy protein isolate | 20.0-80.0 | Protein | 40.0-80.0 |
| Mung bean Protein | 1.0-20.0 | Protein | 1.0-20.0 |
| Potato Protein | 0.5-20.0 | Protein & texture | 0.9-5.5 |
| Chickpea Protein | 1.0-10.0 | Protein & texture | 1.0-5.5 |
| Pea Protein | 0.5-20.0 | Protein & texture | 1.0-5.5 |
| Carrageenan | 5.0-20.0 | Stabilizer | 5.0-10.0 |
| Agar | 5.0-20.0 | Stabilizer | 5.0-10.0 |
| Cellulose fibers | 5.0-15.0 | Fiber | 5.0-10.0 |
| Inulin | 5.0-15.0 | Fiber | 5.0-10.0 |
| Lecithin | 0.5-3.0 | Emulsifier | 0.5-3.0 |
| Gellan | 0.5-2.5 | Thickener | 0.5-2.0 |
| Oil (in liquid) | 1.0-10.0 | Texture | 1.0-10.0 |
| Methyl Cellulose | 4.0-7.0 | Texture | 4.0-6.0 |
| Pea flour | 10.0-20.0 | Texture | 10.0-15.0 |
| Dried Yeast | 5.0-13.0 | Flavor | 5.0-10.0 |
| Sugar | 0.0-10.0 | Flavor | 0.0-5.0 |
| Table Salt | 3.0-6.0 | Flavor | 0.0-5.0 |
| Flavor Powder | 0.5-5.0 | Flavor | 0.0-5.0 |
| Color Powder | 0.4-2.0% | Color | 0.5-1.5 |

Table 5 presents Composition 5, a methyl cellulose free formula of an egg substitute mixture.

TABLE 5

| | % in | | Optimal |
|---|---|---|---|
| Ingredient | powder | Function | range (%) |
| Soy protein isolate | 20.0-80.0 | Protein | 40.0-80.0 |
| Mung bean Protein | 1.0-20.0 | Protein | 1.0-20.0 |
| Potato Protein | 0.5-20.0 | Protein | 0.9-5.5 |
| Chickpea Protein | 1.0-10.0 | Protein | 1.0-5.5 |
| Pea Protein | 0.5-20.0 | Protein | 1.0-5.5 |
| Carrageenan | 5.0-20.0 | Stabilizer | 5.0-10.0 |
| Agar | 5.0-20.0 | Stabilizer | 5.0-10.0 |
| Cellulose fibers | 5.0-15.0 | Fiber | 5.0-10.0 |
| Inulin | 5.0-15.0 | Fiber | 5.0-10.0 |
| Lecithin | 0.5-3.0 | Emulsifier | 0.5-3.0 |
| Gellan | 0.5-2.5 | Thickener | 0.5-2.0 |
| Oil (in liquid) | 1.0-10.0 | Texture | 1.0-10.0 |
| Pea flour | 10.0-20.0 | Texture | 10.0-15.0 |
| Dried Yeast | 5.0-13.0 | Flavor | 5.0-10.0 |
| Sugar | 0.0-10.0 | Flavor | 0.0-5.0 |
| Table Salt | 3.0-6.0 | Flavor | 0.0-5.0 |
| Flavor Powder | 0.5-5.0 | Flavor | 0.0-5.0 |
| Color Powder | 0.4-2.0% | Color | 0.5-1.5 |

### Example 3

### Effect of Ingredients in the Egg Substitute Compositions

The main technological challenges in plant based egg substitute development are: (a) to obtain a flowing fluid with relatively low viscosity, (b) that it heat stable and would not disintegrate during frying (due to binding and adhesiveness forces at high temperatures), (c) result in an omelet appearance, flavor and texture, (d) with high nutritional value.

It is well established that the unique composition off egg is hard to mimic. The functionality of proteins such as ovalbumin, ovotransferrin, ovomucoid, ovomucin in binding, foam formation, gel formation and attributed texture is almost exclusive. In addition, the egg is also rich in fatty acids such as palmitic, stearic, palmitoleic, oleic, arachidonic, linoleic, linolenic, arachidonic, EPA, DPA and DHA.

Therefore, the composition of plant base egg substitute, which would provide the whole range of egg replacement is complex.

### Proteins

In order to obtain functional proteins (good foaming, binding ant omelet texture) with relatively high protein content, the following parameters have to be kept:

Protein content of at least 30% with the following ratio between their combinations: Soy protein/mung bean protein: chickpea protein/pea protein: potato protein—34.0:5.0:1.0; 50.0:5.0:1.5; or 25.5:4.0:1.5.

Soy and mung bean proteins can be used each unaccompanied or in combination.

Chickpea protein and pea protein can be used each unaccompanied or in combination.

### The Effect of Formula Ingredients

The effect of powder formula ingredients (within the range of 0%-150% relative to base formula) on an egg substitute composition egg liquid (flow, spreadability and flipping) omelet (appearance, taste, flavor and texture) were tested. The amount of protein was kept not less than 30%.

The following main results obtained, as function of increasing ingredients' amount in formula are presented in Table 6.

TABLE 6

| | % in | | Effect on | Effect on | Effect on |
|---|---|---|---|---|---|
| Ingredient | powder | Function | Liquid | frying | omelet |
| Soy protein isolate | 20.0-80.0 | Protein | Increased | Reduced | Bitter |
| | | | viscosity | spreadabitily | aftertaste |
| Mung bean Protein | 1.0-20.0 | | Increased | Reduced | Bitter |
| | | | viscosity | spreadabitily | aftertaste |
| Potato Protein | 0.5-20.0 | | Improved | More airy | More airy |
| | | | foam | structure | texture, |
| | | | formation | | potato & |
| | | | | | bitter |
| | | | | | aftertaste |
| Chickpea Protein | 1.0-10.0 | | Improved | More airy | More airy |
| | | | foam | structure | texture, |
| | | | formation | | chickpea |
| | | | | | aftertaste |
| Pea Protein | 0.5-20.0 | | Improved | More airy | More airy |
| | | | foam | structure | texture, |
| | | | formation | | pea |
| | | | | | aftertaste |
| Carrageenan | 5.0-20.0 | Stabilizer | Increased | Improved | Improved |
| | | | viscosity | structure | bite |
| Agar | 5.0-20.0 | | Decreased | NA | Improved |
| | | | viscosity | | bite |
| Methyl Cellulose | 4.0-7.0 | | Increased | Improved | Improved |
| | | | viscosity | adhesion | bite and |
| | | | | and binding | texture |
| | | | | forced | |
| Gellan | 0.5-2.5 | Thickener | Increased | NA | Improved |
| | | | viscosity | | bite and |
| | | | | | texture |
| Cellulose fibers | 5.0-15.0 | Fiber | Increased | NA | Improved |
| | | | viscosity | | bite |
| Inulin | 5.0-15.0 | Fiber | Increased | NA | Improved |
| | | | viscosity | | bite |
| Lecithin | 0.5-3.0 | Emulsifier | Improved | More airy | Improved |
| | | | foam | structure | appearance |
| | | | formation | | and texture |
| Oil | 1.0-10.0 | Fat | Improved | More airy | Improved |
| | | | appearance | structure | texture, |
| | | | and | | taste and |
| | | | decreased | | appearance |
| | | | viscosity | | |
| Pea flour | 10.0-20.0 | Flour | NA | NA | Improved |
| | | | | | bite with |
| | | | | | pea |
| | | | | | aftertaste |
| Dried Yeast | 5.0-13.0 | Flavor | NA | NA | Improved |
| | | | | | appearance, |
| | | | | | improved |
| | | | | | taste with |
| | | | | | yeast |
| | | | | | aftertaste |
| Sugar | 0.0-8.0 | Flavor | NA | Improved | Improved |
| | | | | adhesion | taste and |
| | | | | and binding | appearance, |
| | | | | forced | sweet |
| Table Salt | 3.0-6.0 | Flavor | NA | NA | Improved |
| | | | | | taste, |
| | | | | | salty |
| Flavor Powder | 0.5-5.0 | Flavor | NA | NA | Improved |
| | | | | | taste and |
| | | | | | flavor |
| Color Powder | 0.4-2.0% | Color | NA | NA | Improved |
| | | | | | appearance |

*NA means that current quantities did not affect the studied parameter.

1. In order to obtain a flowing liquid formula which contains at least 30% protein:
the stabilizer has to be agar or carrageenan in a concentration ranging from 5.0-15.0% of the powder, one of them or their combination. In addition, methyl cellulose should be added in a concentration of 4.5%-7.5%, where the ratio between agar & carrageenan (or one of them) and the methyl cellulose should be 3:1-1.5:1, accordingly;
thickener concentration should be not more than 2.5%; and
the dilution ratio between the water or oil & water and the egg substitute composition egg powder should be within the range of 12.0:1.0-7.0:1.0.

2. In order to obtain a high performance formula during frying which contains at least 30% protein:
the formula should contain at least 1.5% of chickpea protein, potato protein or pea protein combination, where the ratio between them should be within the range of about 5.0:1:0.0; 5.0:1.0:1.0, 5.0:1.5:1.0; and
the stabilizer has to be agar or carrageenan in a concentration ranging from 5.0-15.0% of the powder, one of them or their combination. In addition, methyl cellulose should be added in a concentration of 4.5%-7.5%, where the ratio between agar & carrageenan (or one of them) and the methyl cellulose should be 3:1-1.5:1, accordingly.

3. In order to obtain a tasty plant based omelet (appearance, taste & flavor and texture) compared with egg based omelet, which contains at least 30% protein:
the stabilizer has to be agar or carrageenan in a concentration ranging from 5.0-15.0% of the powder, one of them or their combination. In addition, methyl cellulose should be added in a concentration of 4.5%-7.5%, where the ratio between agar & carrageenan (or one of them) and the methyl cellulose should be 3:1-1.5:1, accordingly;
the thickener has to be gelan, with concentration between the range of 0.5-2.5% of the powder;
fiber content (cellulose, inulin or their combination) has to be within the range of 5.0-15.0% of the powder;
lecithin (0.5%-3.0%) and oil (1.0-10.0%) could be added to increase the quality of the omelet;
pea flour with range of 10.0-20.0% of the powder, to improve the bite of the omelet;
in order to improve the appearance, taste & odor profiles of the omelet, dried yeasts (5.0%-13.0%, sugar 0.0%-8.0%, salt 3.0%-6.0%) and flavor powder (0.5-5.0%) should be added; and
in order to improve the color of the omelet, color should be added at a concentration of 0.4-2.0% of the plant base egg substitute powder.

### Rheological Data

Rheological data is presented in Table 7.

TABLE 7

| | | Viscosity as |
|---|---|---|
| Formula | Composition | fluid [cP] |
| 3 | Reference formula* | 6,850 |
| 5 | Carrageenan free** | 2,440 |
| 6 | MC free** | 750 |
| 7 | Carrageenan and MC free** | 500 |

*Reference formula composition:
Soy protein 31%, Potato protein 1.5%, carrageenan 21%, pea flour 16%, Dried yeast 9.6%, cellulose fiber 4.5%, inulin fiber 4.5%, methyl cellulose 6.5%, salt 4.0%, gellan gum 1.0%, lecithin 0.2%, oil 1.0% (in fluid), color (b-carotene) 3.0%.
**Carrageenan and MC were replaced with soy protein.

### Example 4

### Egg Substitute Omelet Texture

The following test demonstrated objectively, the texture of an egg substitute mixture-egg plant based omelet (reference formula) in comparison to an omelet prepared with an egg.

Test Procedure: Each egg substitute mixture omelet was analyzed in triplicates with TPA texture analyzer (AMETEK, Model TA1, LLOYD) as follows: 3 samples with diameter of 3.0 cm were cut from each omelet and placed on the texture analyzer. Samples were pressed till 30% deformation of sample high was reached in velocity of 20 mm/s for 1 sec. Then 2^{nd} press was carried out, illustrating 1^{st} and 2^{nd} bites.

Carrageenan elimination effect on egg substitute mixture-Egg plant based omelet texture is presented in Table 8 and Table 9.

TABLE 8

| | Adhesiveness | Chewiness | Cohesiveness | Firmness | Fracture | |
|---|---|---|---|---|---|---|
| Composition | [Nmm] | [N] | [N] | [N] | [N] | Gumminess |
| Fresh Egg | 4.1 ± 4.3 | 7.8 ± 3.3 | 0.8 ± 0.1 | 21.8 ± 8.6 | 6.0 ± 6.5 | 7.9 ± 3.3 |
| Reference | 4.5 ± 4.2 | 5.0 ± 2.1 | 0.6 ± 0.1 | 13.4 ± 4.2 | 2.4 ± 3.2 | 5.1 ± 2.1 |
| Formula | | | | | | |
| Carrageenan | 1.0 ± 0.7 | 0.5 ± 0.2 | 0.4 ± 0.0 | 2.1 ± 0.7 | 1.5 ± 0.4 | 0.6 ± 0.2 |
| free | | | | | | |

TABLE 9

| | Hardness | Hardness | Stringiness | | |
|---|---|---|---|---|---|
| Composition | Bite 1 | Bite 2 | [mm] | Crispiness | Toughness |
| Fresh Egg | 10.0 ± 4.0 | 21.8 ± 8.6 | 4.1 ± 6.7 | 87.8 ± 28.0 | 9.8 ± 4.0 |
| Reference | 8.7 ± 3.3 | 13.4 ± 4.2 | 3.5 ± 5.0 | 65.7 ± 15.1 | 13.6 ± 7.3 |
| Formula | | | | | |
| Carrageenan | 1.6 ± 0.4 | 2.1 ± 0.7 | 1.5 ± 3.0 | 27.8 ± 2.6 | 2.9 ± 0.3 |
| free | | | | | |

Reference formula gave close texture values compared with a fresh egg.

Replacement of carrageenan with soy, resulted in texture deterioration, as indicated by most tested parameters.

### Example 5

### Taste Panel Results

Sensory evaluation and hedonic tests were carried out with different egg substitute mixture formulations. At each taste session at least five healthy trained participants were assigned (age range: 27-70).

Before each tasting, participants were asked to wash their mouth at least twice with mineral water.

The participants were asked to rate the following parameters between 1-10, where 10 is the highest score, in comparison to an egg: fluid flowing*, spreadability* on the pan during frying, flipping* during frying, final omelet evaluation: appearance, flavor, taste, texture.

*The score of flow, spreadability and flipping were given after the participant watched a video of each Zero-egg formula preparation.

### Results:

### Formula: Reference Formula

Fluid: Liquefaction: 8.0; Spreadability: 8.3; Flipping: 9.5

Omelet: Appearance: 9.3; Texture: 7.2; Taste: 7.3; Odor: 8.7

### Example 6

### Egg Substitute Composition Application in Baked Products

The following recipe presented in Table 10 was used to prepare chocolate cake, vanilla cake, marble cake, meringue and muffins successfully.

TABLE 10

Recipe

| | Zero Egg | Reference Recipe |
|---|---|---|
| Ingredient | % Total Weight | % Total Weight |
| Liquid Egg Substitute | 3.5-6.0 | — |
| composition | | |
| Liquid whole egg | — | 14 |
| Oil | 5.0-10 | 12 |
| Sugar | 20-30 | 22 |
| Orange juice | 10-15 | 17 |
| Water | 10-15 | 9 |
| Self-raising flour | 30-35 | 26 |
| Total | | 100% |

A taste test was carried out. Eighteen healthy participants (aged 24-70) were asked to taste the cake and answer the questioner, in relation to the original cake. The test was carried out during the afternoon, after all participants had their lunch.

General score of the appearance is very good (>9). The general opinion and the texture are good (>8) (Table 11).

TABLE 11

| | | | After tasting | | | |
|---|---|---|---|---|---|---|
| No. of | Before tasting | | General | | | Texture/ |
| tasters | Appearance | Odor | opinion | Flavor | Airy | Mouthfeel |
| 18 | 9.28 ± 1.1 | 8.83 ± 1.3 | 8.06 ± 1.5 | 7.56 ± 2.1 | 7.61 ± 1.9 | 8.28 ± 1.6 |

50% of the tasters felt like the cake is just sweet enough as it should be (Table 12).

TABLE 12

| | Sweetness | | | | |
|---|---|---|---|---|---|
| | Much | Slightly | | Slightly | Much |
| Number of | more than | more than | Just as | less than | less than |
| tasters | I like | I like | I like | I like | I like |
| 18 | 11% | 22% | 50% | 17% | 0% |

Most tasters felt that the airiness is just as it should be (Table 13).

TABLE 13

| | Airy Texture | | | | |
|---|---|---|---|---|---|
| | Much | Slightly | | Slightly | Much |
| Number of | more than | more than | Just as | less than | less than |
| tasters | I like | I like | I like | I like | I like |
| 18 | 0% | 0% | 67% | 22% | 11% |

The flavors of the cakes were overall typical (Table 14).

TABLE 14

| Number of | How typical is the cake flavor | | | |
|---|---|---|---|---|
| tasters | Very much | Pretty typical | Not so much | Not at all |
| 12 | 58% | 33% | 8% | 0% |
| 6 | 83% | 17% | 0% | 0% |
| 18 | 67% | 28% | 6% | 0% |

The textures of the cakes were overall typical (Table 15).

TABLE 15

| Number of | How typical is the cake texture | | | |
|---|---|---|---|---|
| tasters | Very much | Pretty typical | Not so much | Not at all |
| 18 | 78% | 11% | 6% | 6% |

Most tasters did not feel any off-flavors, but those who did felt slight or strong after-taste (Table 16).

TABLE 16

| Number of | Off-flavor | | | | |
|---|---|---|---|---|---|
| tasters | Not at all | Slight | medium | strong | very strong |
| 18 | 56% | 28% | 0% | 17% | 0% |

Most of the tasters don't consume cakes frequently as more than once a week (Table 17).

TABLE 17

| | How often do you consume these kinds of cakes? | | | | | |
|---|---|---|---|---|---|---|
| | | 4-5 | 2-3 | once | once | once |
| Number of | Every | times | times | a | in 2-3 | a month |
| tasters | day | a week | a week | week | weeks | or less |
| 18 | 11% | 11% | 17% | 28% | 28% | 6% |

Only one taster was vegan (Table 18).

TABLE 18

| Number of | General questions |
|---|---|
| tasters | Are you vegan? |
| 18 | 6% |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising:
a. 25% to 80% (w/w) protein;
b. 5% to 50% (w/w) Fabaceae flour; and
c. 5% to 60% (w/w) polysaccharide, wherein said protein and said polysaccharide are in a w/w ratio of 1:0.1 to 1:1.

2. The composition of claim 1, further comprising 1% to 20% (w/w) yeast extract.

3. The composition of claim 1, further comprising 1% to 20% (w/w) fiber.

4. (canceled)

5. The composition of claim 1, wherein said polysaccharide is agar, methyl cellulose, carrageenan, or any combination thereof.

6. The composition of claim 1, wherein said protein is a plant protein, vegetable protein, a legume protein, a seed protein, a grain protein, a tuber protein, a root protein, a fruit protein, hemp protein, a nut protein, an algae protein, a seaweed protein, or any combination thereof.

7. A composition comprising (a) 25% to 80% (w/w) soy protein, potato protein, or both; (b) 5% to 50% (w/w) pea flour; (c) 10% to 60% (w/w) carrageenan, methyl cellulose, or both; (d) 1% to 20% (w/w) fiber; and (e) 1% to 20% (w/w) yeast extract.

8. The composition of claim 1, further comprising 1% to 20% (w/w) mung bean protein, chickpea protein, pea protein, or any combination thereof.

9. The composition of claim 7, further comprising 0.1% to 5% (w/w) salt.

10. The composition of claim 7, further comprising: a stabilizer, a thickener, an emulsifier, a food coloring agent, a flavoring agent or any combination thereof.

11. The composition of claim 10, wherein said stabilizer, said thickener, said emulsifier, said food coloring agent, said flavoring agent or any combination thereof, is/are in an amount of up to 15% (w/w) of the total composition.

12. The composition of claim 7, wherein said composition is in a liquid form or dry powder form.

13. The composition of claim 12, wherein said liquid comprises water, oil, or both.

14. A kit comprising the composition of claim 7 and mixing instructions.

15. The kit of claim 14, wherein said instructions comprise instructions for:
a. mixing said composition with a liquid and obtaining a mixture; and
b. applying the mixture to the preparation of a food product, a recipe which requires an amount of egg yolks, egg whites, or whole eggs, thereby substituting said eggs in said food product or recipe.

16. A method for substituting eggs in a food product or a recipe, comprising the step of: (a) mixing the composition of claim 7 with a liquid and obtaining a mixture; (b) applying the mixture to the preparation of said food product, said recipe which requires an amount of egg yolks, egg whites, or whole eggs, thereby substituting said eggs in said food product or recipe.

17. A method for preparing an egg food product, comprising substituting egg yolks, egg whites, or whole eggs needed for the preparation of said food product, with the composition of claim 7.

18. A food product comprising the composition of claim 7.

19. The food product of claim 18, wherein said food product has at least 80% of the texture, color, and flavor of an equivalent product prepared using eggs.

20. The food product of claim 7, devoid of an egg or any portion thereof.

21. The food product of claim 18, wherein said food product is vegan.
